(19) United States
(12) Patent Application Publication
(10) Pub. No.: US 2026/0168916 A1
(43) Pub. Date: Jun. 18, 2026

(54) Stick-Slip Measurement Apparatus and Stick-Slip Measurement Method Using the Same

(71) Applicants: HYUNDAI MOTOR COMPANY, SEOUL (KR); KIA CORPORATION, SEOUL (KR); KOREA UNIVERSITY RESEARCH & BUSINESS FOUNDATION, Seoul (KR)

(72) Inventors: Kyung Woo Lee, Hwaseong-si (KR); Dae Un Sung, Hwaseong-si (KR); Seong Ho Yoon, Seoul (KR); Jun Young Yoon, Seoul (KR); Byoung Ho Choi, Seoul (KR); Sang Min Lee, Seoul (KR)

(73) Assignees: HYUNDAI MOTOR COMPANY, SEOUL (KR); KIA CORPORATION, SEOUL (KR); KOREA UNIVERSITY RESEARCH & BUSINESS FOUNDATION, Seoul (KR)

(21) Appl. No.: 19/323,640

(22) Filed: Sep. 9, 2025

(30) Foreign Application Priority Data
Dec. 17, 2024 (KR) 10-2024-0188775

(51) Int. Cl. G01N 19/02

(52) U.S. Cl. CPC G01N 19/02; G01N 2203/021; G01N 2203/0254; G01N 2203/0658; G01N 2203/0676

(57) ABSTRACT

A stick-slip measurement apparatus includes: a friction test unit configured to provide variable friction conditions to test specimens; a measurement unit configured to acquire vibration and sound pressure data based on the friction conditions; and a data processing unit configured to convert the data transmitted from the measurement unit into a level value. The level value is a single feature value indicating a magnitude based on a signal processing technique. Additionally, the apparatus includes a display unit configured to display information converted using the level value converted by the data processing unit as a response curve equation graph. A vibration level value or a sound pressure level value for untested friction conditions is predicted using the response curve.

This application claims the benefit of and priority to Korean Patent Application No. 10-2024-0188775, filed on Dec. 17, 2024, which is hereby incorporated by reference as is fully set forth herein.

### BACKGROUND

### Technical Field

The present disclosure relates to a stick-slip measurement apparatus and a stick-slip measurement method using the same. More particularly, the present disclosure relates to a stick-slip measurement apparatus capable of predicting behavior outside of test conditions through a response curve equation based on variable test conditions and a stick-slip measurement method using the same.

### Discussion of the Related Art

Stick-slip refers to the phenomenon in which two objects in contact slid against each other and then one of the objects suddenly moves.

FIG. 1 illustrates a stick-slip phenomenon. As shown, stick-slip occurs from state (1) to state (5) due to the interaction between the time-dependent frictional properties and a test apparatus. Stick-slip is a phenomenon in which two objects in contact with each other are separated from each other (faulting (slip)) when force exceeding a critical value is applied thereto in a fixed state (stick).

In vehicle parts, noise caused by stick-slip occurs when a vehicle is moving. The noise caused by stick-slip is difficult to understand due to various factors, and improvements are insufficient. Conventional stick-slip measurement apparatuses and measurement methods require direct testing in all cases, which is time-consuming and labor-intensive, and there are difficulties in processing the vast amount of test result data generated after the test. Therefore, there is a desire for a test apparatus and method for measuring the characteristics of stick-slip based on various factors and technology for processing and simplifying the same to check the response.

### SUMMARY

Accordingly, the present disclosure is directed to a stick-slip measurement apparatus and a stick-slip measurement method using the same that substantially obviate one or more technical problems due to limitations and disadvantages of the related art.

It is an object of the present disclosure to provide a stick-slip measurement apparatus and method capable of evaluating the characteristics of vehicle part specimens by measuring noise and vibration due to stick-slip generated between the vehicle part specimens under various conditions.

It is another object of the present disclosure to provide a stick-slip measurement apparatus capable of predicting noise and vibration for friction conditions that have not been tested.

To achieve the above objects and other advantages and in accordance with the purpose of the present disclosure, as embodied and broadly described herein, a stick-slip measurement apparatus includes a friction test unit configured to provide at least one friction condition among a variety of friction conditions to at least two test specimens. The apparatus also includes a measurement unit configured to acquire vibration data or sound pressure data when the at least one friction condition is being applied to the at least two test specimens. Additionally, the apparatus includes a data processing unit configured to convert the vibration data or the sound pressure data into a level value. The level value is a single feature value indicating a magnitude. Additionally, the apparatus includes a display unit configured to display a response curve equation graph associated with the level value.

In the stick-slip measurement apparatus according to the present disclosure, the friction test unit may include: a test jig configured to allow placement of the at least two test specimens; a condition setting portion configured to provide friction condition information applied to the at least two test specimens; and a friction velocity variable portion configured to apply horizontal friction to the at least two test specimens based on the friction condition information. Additionally, the friction test unit may include a vertical load variable portion configured to apply vertical load to the at least two test specimens based on the friction condition information.

In the stick-slip measurement apparatus according to the present disclosure, the two test specimens may be made of the same material, such as a polymer and a polymer or a metal and a metal, or different materials, such as rubber and plastic or rubber and a metal.

In the stick-slip measurement apparatus according to the present disclosure, the measurement unit may include an accelerometer configured to measure a magnitude of vibration generated from the at least two test specimens, or a microphone configured to measure a magnitude of sound pressure generated from the at least two test specimens.

In the stick-slip measurement apparatus according to the present disclosure, the data processing unit may include: a data conversion portion configured to convert time domain data provided by the measurement unit into frequency domain data by a fast Fourier transform; a band pass filter configured to extract predetermined frequency zone data from the frequency domain data; and a level value conversion portion configured to convert the extracted data into a single decibel value.

In the stick-slip measurement apparatus according to the present disclosure, the data processing unit may apply frequency weighting to the extracted data.

In the stick-slip measurement apparatus according to the present disclosure, the response curve equation graph may include a vibration acceleration level value based on a friction velocity and a vertical load.

In the stick-slip measurement apparatus according to the present disclosure, the response curve equation graph may include a predicted value for a vibration acceleration level value of an untested condition of a friction velocity and a vertical load.

In another aspect of the present disclosure, a stick-slip measurement method includes: a test preparation step of setting various test conditions for friction velocity and vertical load applied to at least two test specimens; a test and measurement step of acquiring vibration data or sound pressure data generated from the at least two test specimens; and a data processing step of converting the vibration data or the sound pressure data into a level value. The level value is a single feature value associated with a magnitude. The method also includes a display step of displaying a response curve equation graph associated with the level value.

In the stick-slip measurement method according to the present disclosure, the test and measurement step may include: measuring a magnitude of vibration generated from the at least two test specimens using an accelerometer, and measuring a magnitude of sound pressure generated from the at least two test specimens using a microphone.

In the stick-slip measurement method according to the present disclosure, the data processing step may include: a data conversion step of converting time domain data measured in the test and measurement step into frequency domain data by a fast Fourier transform; and a frequency signal extraction step of extracting predetermined frequency zone data from the frequency domain data. The data processing step may also include a level value conversion step of converting the extracted data into a single decibel value.

In the stick-slip measurement method according to the present disclosure, the level value conversion step may include applying frequency weighting to the extracted data.

In the stick-slip measurement method according to the present disclosure, the response curve equation graph may include a vibration acceleration level value based on a friction velocity and a vertical load.

In the stick-slip measurement method according to the present disclosure, the response curve equation graph may include a predicted value for a vibration acceleration level value of an untested condition of a friction velocity and a vertical load.

It should be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 explains stick-slip;

FIG. 2 is a block diagram showing a configuration of a stick-slip measurement apparatus according to the present disclosure;

FIG. 3 is a block diagram showing a configuration of a friction test unit of FIG. 2;

FIG. 4 is a block diagram showing a configuration of a measurement unit of FIG. 2;

FIG. 5 is a block diagram showing a configuration of a data processing unit of FIG. 2;

FIG. 6 is a flowchart showing a stick-slip measurement method according to the present disclosure;

FIG. 7 is a flowchart showing a test and measurement step of FIG. 6;

FIG. 8A is a flowchart showing a vibration data processing process in a stick-slip measurement method according to the present disclosure;

FIG. 8B is a flowchart showing a noise data processing process in a stick-slip measurement method according to the present disclosure;

FIGS. 9A to 9F are illustrative views showing sound pressure data extracted during execution of a stick-slip measurement method according to the embodiment of the present disclosure shown in FIG. 8B; and

FIG. 10 is a response curve equation graph based on results of a stick-slip measurement method according to the present disclosure.

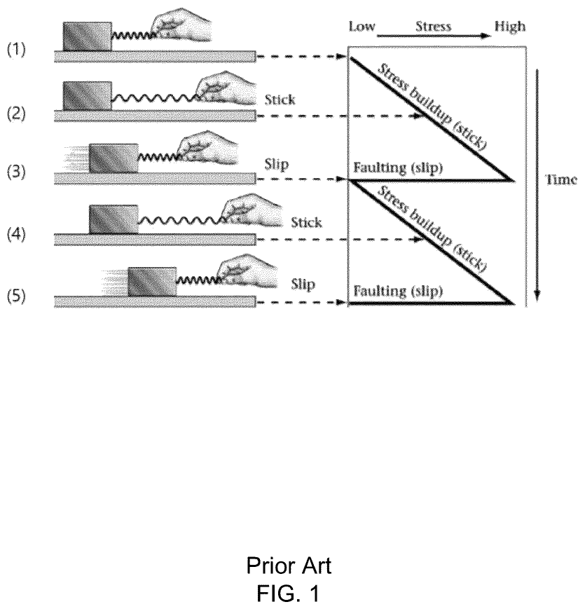

### DETAILED DESCRIPTION

Specific structural or functional descriptions of the embodiments of the present disclosure disclosed in this specification are given only for illustrating embodiments of the present disclosure. Embodiments of the present disclosure may be realized in various forms, and should not be interpreted to be limited to the embodiments of the present disclosure disclosed in this specification.

Since the present disclosure may be variously modified and may have various forms, specific embodiments are shown in the drawings and are described in detail in this specification. However, the present disclosure is not limited to the specific embodiments, and it should be understood that the present disclosure includes all alterations, equivalents, and substitutes that fall within the idea and technical scope of the present disclosure.

It should be understood that, although the terms “first”, “second”, and the like may be used herein to describe various elements, corresponding elements should not be understood to be limited by these terms, which are used only to distinguish one element from another. For example, within the scope defined by the present disclosure, a first element may be referred to as a second element, and similarly, a second element may be referred to as a first element.

It should be understood that, when an element is referred to as being “connected to” or “coupled to” another element, it may be directly connected to or coupled to the other element, or intervening elements may be present. In contrast, when an element is referred to as being “directly connected to” or “directly coupled to” another element, there are no intervening elements present. Other terms that describe the relationship between elements, such as “between” and “directly between” or “adjacent to” and “directly adjacent to”, may be interpreted in the same manner. Similarly, “disposed on” may mean that an element is disposed directly on the surface of another element or disposed above another element so as to be spaced apart therefrom.

The terms used in this specification are provided only to explain specific embodiments, but are not intended to restrict the present disclosure. A singular representation may include a plural representation unless it represents a definitely different meaning from the context. It should be further understood that the terms “includes”, “has” and the like, when used in this specification, specify the presence of stated features, numbers, steps, operations, elements, components, or combinations thereof, but do not preclude the presence or addition of one or more other features, numbers, steps, operations, elements, components, or combinations thereof.

Unless otherwise defined, all terms, including technical and scientific terms, used in this specification have the same meanings as those commonly understood by a person having ordinary skill in the art to which the present disclosure pertains. It should be further understood that terms, such as those defined in commonly used dictionaries, should be interpreted as having meanings consistent with their meanings in the context of the relevant art and the present disclosure, and are not to be interpreted in an idealized or overly formal sense unless expressly so defined herein.

When a certain embodiment is differently realized, a function or operation specified in a specific block may be performed differently from the sequence specified in a flowchart. For example, two continuous blocks may be substantially simultaneously performed, or the blocks may be performed in reverse order depending on related functions or operations.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, a stick-slip measurement apparatus according to the present disclosure and a stick-slip measurement method using the same are described with reference to the accompanying drawings.

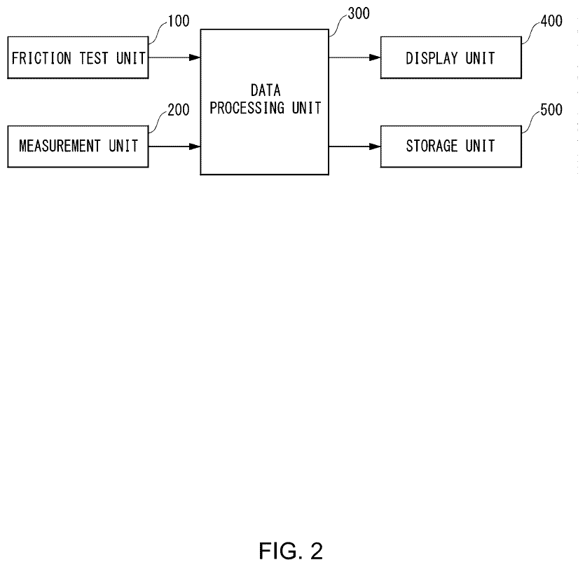

FIG. 2 is a block diagram showing the configuration of a stick-slip measurement apparatus according to the present disclosure. As shown, the stick-slip measurement apparatus according to the present disclosure includes a friction test unit 100, a measurement unit 200, a data processing unit 300, a display unit 400, and a storage unit 500.

The friction test unit 100 provides a variety of variable friction conditions for testing using test vehicle part specimens (e.g., a first specimen, a second specimen, and the like).

The measurement unit 200 acquires vibration and sound pressure data generated when the friction conditions are applied to the test vehicle part specimens.

The data processing unit 300 converts the data transmitted from the measurement unit 200 into a level value, which is a single feature value that represents a meaningful magnitude, based on a signal processing technique.

The display unit 400 displays information converted using the level value converted by the data processing unit 300 as a response curve equation graph.

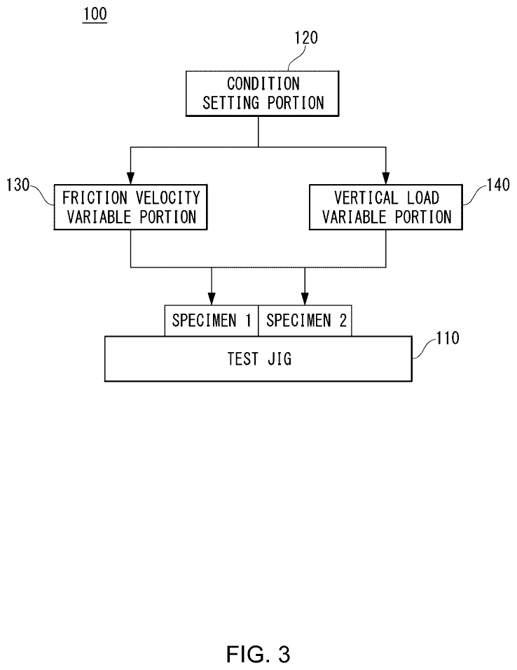

FIG. 3 is a block diagram showing the configuration of the friction test unit of FIG. 2. As shown, the friction test unit 100 includes a test jig 110, a condition setting portion 120, a friction velocity variable portion 130, and a vertical load variable portion 140.

The test specimens are mounted on the test jig 110. The test specimens are coupled to each other to form a single vehicle part, and may be made of the same material. For example, specimen A, which is made of a polymer, and specimen B, which is made of a polymer identical or similar to the polymer of specimen A, may be mounted to measure vibration and sound pressure data caused by friction between the two specimens. Specimen A and specimen B may be made of the same metal as well as the same polymer. The test specimens may be made of different materials. For example, the characteristics due to stick-slip between specimen A made of leather and specimen B made of PVC may be measured. Alternatively, the characteristics due to stick-slip between specimen A made of a polymer and specimen B made of a metal may be measured. The size or the shape of the test specimens may be changed in addition to the material of the test specimens based on the user's intention. In other words, the stick-slip measurement apparatus according to the present disclosure does not limit or specify the test specimens.

The condition setting portion 120 that provides friction condition information applied to the test specimens may be implemented, e.g., as an apparatus equipped with a processor that can execute a program, such as a computer. The friction velocity variable portion 130 performs an operation that can apply horizontal friction to the test specimens based on the friction condition information provided from the condition setting portion 120. The vertical load variable portion 140 performs an operation that can apply vertical load to the test specimens based on the friction condition information provided from the condition setting portion 120. In this embodiment, the vertical load condition applied to the specimens is changed, but the horizontal load condition may be changed or both the horizontal and vertical load conditions may be changed.

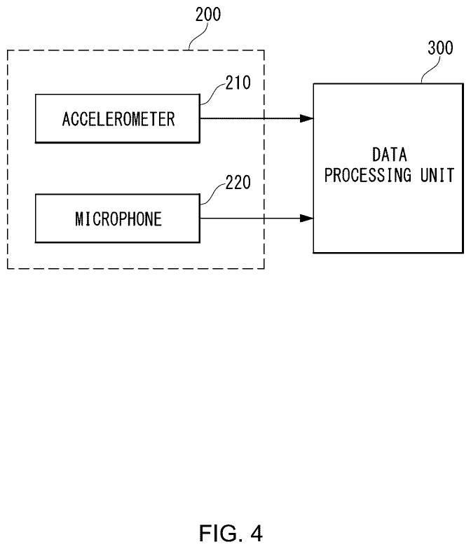

FIG. 4 is a block diagram showing the configuration of the measurement unit of FIG. 2. The measurement unit 200 may include an accelerometer 210 configured to measure the magnitude of vibration and a microphone 220 configured to measure the magnitude of sound pressure.

The accelerometer 210 is disposed adjacent to the test jig 110 to measure the magnitude of the vibration generated when the friction velocity and vertical (or horizontal) load that satisfy the set conditions are applied to the test vehicle part specimens.

The microphone 220 is disposed adjacent to the test jig 110, particularly between the two specimens, to measure the magnitude of sound pressure generated in the friction condition test applied to the test specimens.

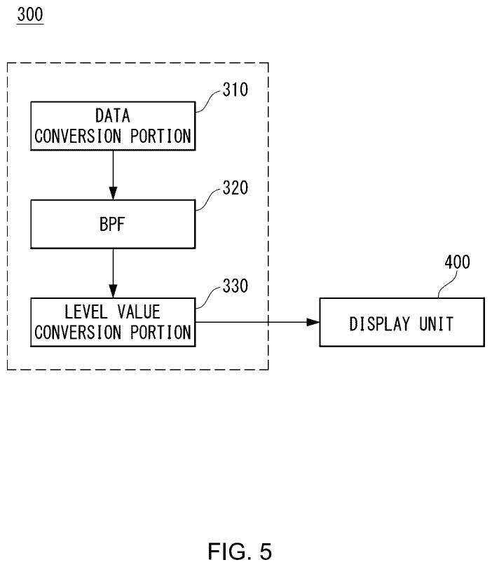

FIG. 5 is a block diagram showing the configuration of the data processing unit of FIG. 2. The data processing unit 300 includes a data conversion portion 310, a band pass filter (BPF) 320, and a level value conversion portion 330.

The data conversion portion 310 converts a time domain signal of the vibration and sound pressure measurement data provided by the accelerometer 210 and the microphone 220 of the measurement unit 200 into a frequency domain signal using the fast Fourier transform.

The band pass filter 320 extracts only the set frequency domain signal from the data converted by the data conversion portion 310.

The level value conversion portion 330 converts each of the vibration and sound pressure data extracted by passing through the band pass filter 320 into a single decibel value required to generate the response curve equation using root mean square.

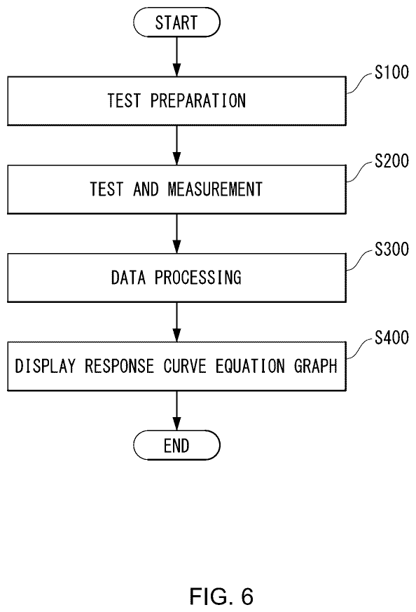

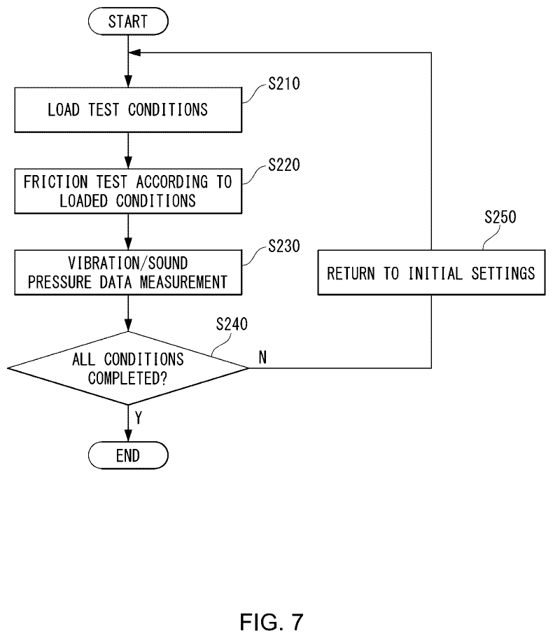

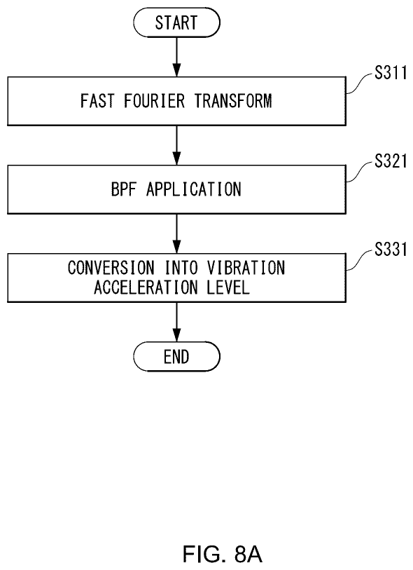

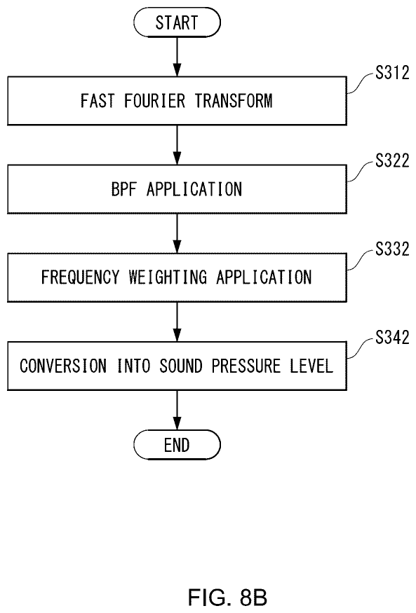

FIG. 6 is a flowchart showing a stick-slip measurement method according to the present disclosure. FIG. 7 is a flowchart showing a test and measurement step of FIG. 6. FIGS. 8A and 8B are flowcharts respectively showing vibration data and sound pressure data processing process in the stick-slip measurement method according to the present disclosure.

As shown in FIG. 6, the stick-slip measurement method according to the present disclosure includes a test preparation step (S100) of setting various test conditions for the friction velocity and vertical load applied to test specimens, and a test and measurement step (S200) of acquiring vibration and sound pressure data generated from the test specimens for the friction and vertical load provided based on the test conditions. The method further includes a data processing step (S300) of converting the measured vibration and sound pressure data into a level value, which is a single feature value representing a magnitude, based on a signal processing technique. Additionally, the method includes a display step (S400) of displaying information converted using the converted level value as a response curve equation graph.

The test and measurement step (S100) includes measuring the magnitude of vibration generated in the friction condition test applied to the test specimens using the accelerometer disposed adjacent to the test jig and measuring the magnitude of sound pressure generated in the friction condition test applied to the test specimens using the microphone disposed adjacent to the test jig. Unlike conventional measurement methods that are performed only under a single condition, the stick-slip measurement method according to the present disclosure may perform the test using a friction tester that allows a user to set the test plan conditions and an automation program. The values and ranges of friction velocity, vertical load (or horizontal load), friction distance, and the like, may be input based on the test plan using an automation program of a control computer. When the test is started under the conditions input to the control computer, the test is performed automatically and repeatedly until all conditions are completed for the pair of test specimens. The automated test operation is performed as shown in the flowchart shown in FIG. 7.

The test conditions are loaded into the friction velocity variable portion 130 and the vertical load variable portion 140 (S210), and the friction test is performed based on the loaded conditions (S220). Vibration and sound pressure data generated by the test specimens for the friction velocity and the vertical load applied to the specimens are acquired based on the test (S230). It is determined whether the loaded test conditions satisfy all the conditions of the automated test (S240). If all the test conditions have not been completed, return to the initial setting value is performed, and the test based on the next setting conditions is performed. After the test of each condition, return to the initial settings is performed, and the next test is prepared. After one automated test is completed, the automated test may be performed in the same way for another pair of specimens. The measured vibration and sound pressure data may be transmitted to the data processing unit 300 and stored in the storage unit 500 at the same time (S250).

The raw data measured through the test and measurement step is converted into a level value, which is a single feature value that represents a meaningful magnitude, based on a signal processing technique developed for test conditions and characteristics through the process shown in FIGS. 8A and 8B, by the data processing unit 300.

FIG. 8A is a flowchart showing a vibration data processing process in the stick-slip measurement method according to the present disclosure.

The data conversion portion 310 of the data processing unit 300 converts a time domain signal of the raw vibration measured in the test and measurement step into a frequency domain signal using the fast Fourier transform (S311).

For the data converted by the data conversion portion 310, only the signal in the frequency band that has passed through the frequency domain set by the band pass filter 320 is extracted (S321).

The extracted vibration data is converted into a vibration acceleration level having a single level value required to generate a response curve equation graph using the root mean square by the level value conversion portion 330 (S331).

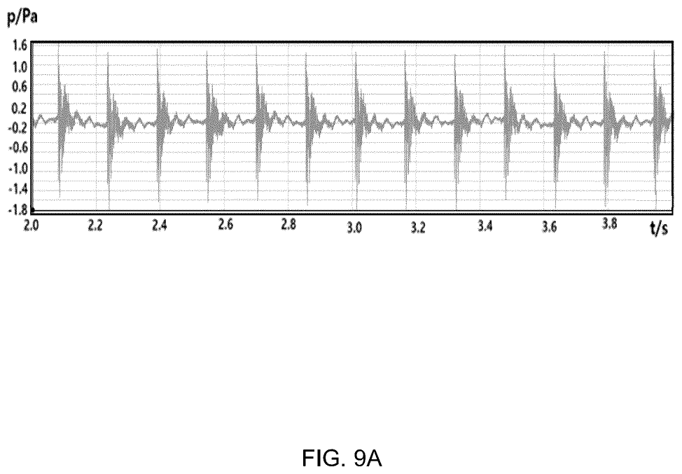

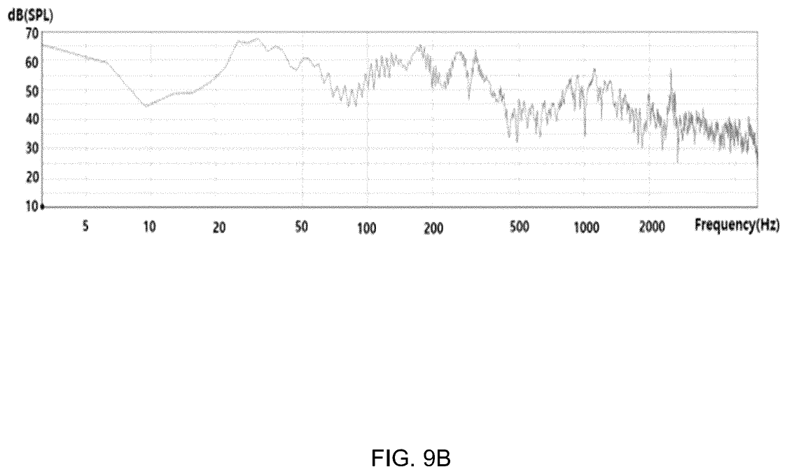

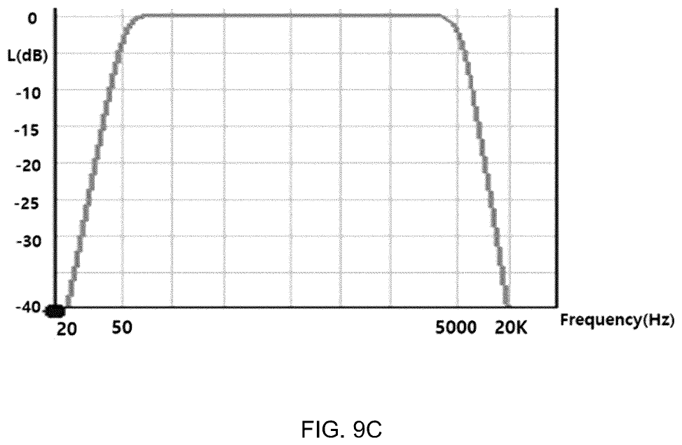

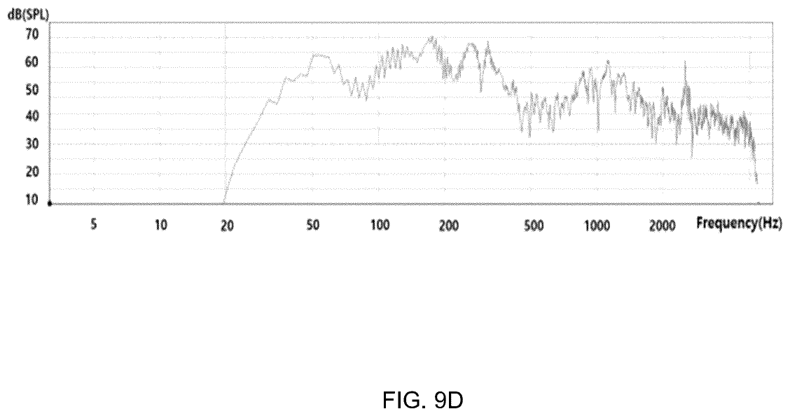

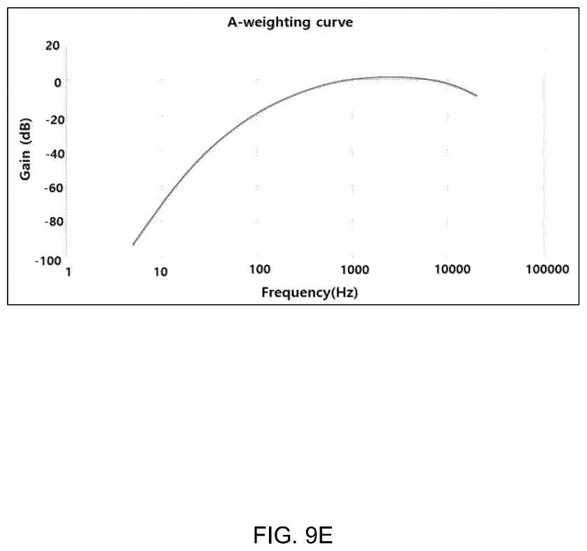

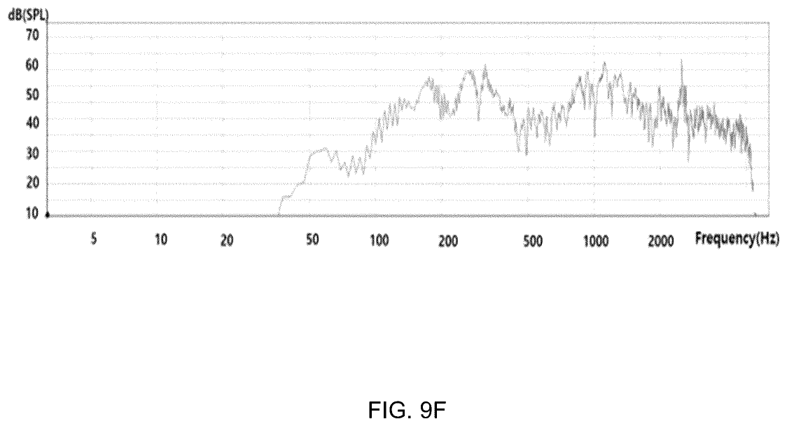

FIG. 8B is a flowchart showing a noise data processing process in the stick-slip measurement method according to the present disclosure. FIG. 9 is an illustrative view showing sound pressure data extracted during the execution of the stick-slip measurement method according to the embodiment of the present disclosure shown in FIG. 8B.

FIG. 9A shows time-domain sound pressure data measured by the measurement unit 200.

The data conversion portion 310 of the data processing unit 300 converts the raw sound pressure data of the time domain state measured by the measurement unit 200 in the test and measurement step into sound pressure data in the frequency domain using the fast Fourier transform, as shown in FIG. 9B (S312).

For the data converted by the data conversion portion 310, only the signal in the frequency band that has passed through the frequency domain set by the band pass filter 320 is extracted. The range of frequencies that pass through the band pass filter 320 is called the passband. The cutoff frequency is the boundary between the frequency band through which a signal passes and the frequency band through which the signal does not pass. In the band pass filter, the area between the two cutoff frequencies becomes the passband, through which the signal passes. For example, as shown in FIG. 9C, a sound pressure data signal in the frequency band, excluding signals in the cutoff frequency range (a frequency band of 50 Hz or less and a frequency band of 5,000 Hz or more), passes through a band pass filter 320 having a lower cutoff frequency of 50 Hz and a higher cutoff frequency of 5,000 Hz, which is shown in FIG. 9D (S322).

The sound pressure data signal that has passed through the band pass filter is additionally subjected to frequency weighting (A-weighting), as shown in FIG. 9E. Thus, the sound pressure data signal is converted into a sound similar to a sound in an audible frequency band perceived by humans, as shown in FIG. 9F (S332).

The sound pressure data in the audible frequency band is converted into a sound pressure level having a single level value required to generate a response curve equation graph using the root mean square by the level value conversion portion 330 (S342).

When assuming that the result of the fast Fourier transform of the acceleration at a predetermined frequency f is A(f), the frequency resolution is Δf, the lower limit of the frequency band of interest is f1, and the upper limit of the frequency band of interest is f2, the level value conversion portion 330 converts vibration data and sound pressure data into a single decibel value through the following equations.

For example, the process of converting vibration data is performed through the following equations.

$${PSD}_{a} ( f ) = \frac{{\vert A ( f ) \vert}^{2}}{Δ f}$$

$${a}_{rms} = \sqrt{{\int }_{{f}_{1}}^{{f}_{2}} {PSD}_{a} ( f ) df}$$

$$VAL = 20 log ( \frac{{a}_{rms}}{{10}^{- 6}} )$$

The process of converting sound pressure data may be expressed by the following equations.

$${PSD}_{p} ( f ) = \frac{{\vert P ( f ) \vert}^{2}}{Δ f}$$

$${p}_{rms} = \sqrt{{\int }_{{f}_{1}}^{{f}_{2}} {PSD}_{p} ( f ) df}$$

$$SPL = 20 log ( \frac{{p}_{rms}}{2 \times {10}^{- 5}} )$$

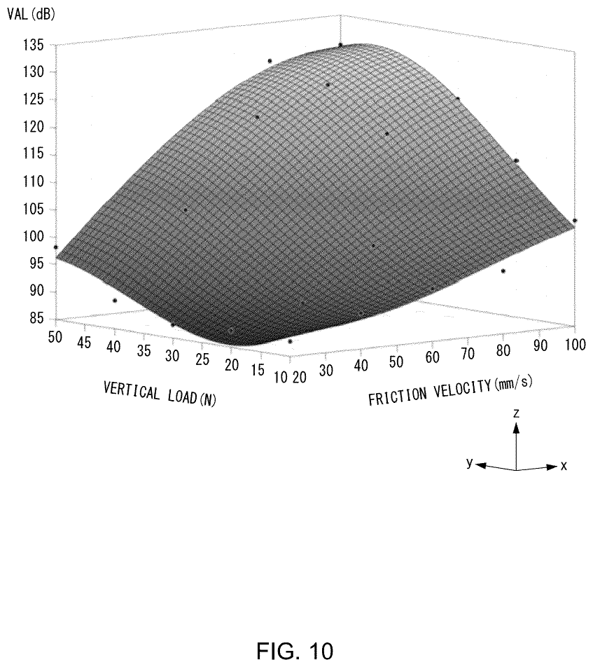

FIG. 10 is a response curve equation graph based on the results of the stick-slip measurement method according to the present disclosure.

When the x-axis represents the friction velocity based on each test condition and the y-axis represents the vertical load based on each test condition, a data set that displays the value of a vibration acceleration level or a sound pressure level, which is a result value based on each test condition, on the z-axis is configured. The response curve equation graph includes a predicted value of the vibration acceleration level for the untested condition, which is not tested between the existing test conditions applied to the specimens. Therefore, a three-dimensional response curve prediction equation for the friction velocity and the vertical load may be established based on the test data of the decibel value processed using an analysis computer. In other words, a curve equation that can predict vibration and sound pressure for the untested period is configured. The response curve of the third-order polynomial for X and Y with the minimum error with respect to the value of Z is optimized using a least squares method. The reliability and accuracy of the configured response curve may be verified using the determination coefficient and the mean-squared error of the response curve. The vibration acceleration level or the sound pressure level may be predicted for any friction velocity and vertical load using the configured third-order polynomial response curve.

In FIG. 10, dots in the lower left graph represent the friction test result data for each test condition, and the curve represents the response curve formed through response curve optimization. Using this, the level value based on the untested conditions may be calculated through the following equation using values shown in [Table 1].

TABLE 1

| Paramater | Value | Confidence Interval |
|---|---|---|
| P00 | 60.72 | (27.02, 94.42) |
| P10 | −0.6248 | (−1.992, 0.7421) |
| P01 | −0.4447 | (−3.178, 2.289) |
| P20 | 0.0113 | (−0.01129, 0.03388) |
| P11 | 0.01089 | (−0.01892, 0.0407) |
| P02 | 0.01416 | (−0.07616, 0.1045) |
| P30 | −4.91E−5 | (−0.0001704, 7.219e−05) |
| P21 | −0.000109 | (−0.000283, 6.496e−05) |
| P12 | 9.63E−5 | (−0.0002516, 0.0004442) |
| P03 | −0.000184 | (−0.001154, 0.0007863 |

$$z = {p}_{30} {x}^{3} + {p}_{21} {x}^{2} y + {p}_{20} {x}^{2} + {p}_{12} {xy}^{2} + {p}_{11} xy + {p}_{10} x + {p}_{03} {y}^{3} + {p}_{02} {y}^{2} + {p}_{01} y + {p}_{00}$$

In [Table 1], the parameter represents the name of the coefficient of each term of the response curve equation, and the value represents the value of the coefficient. The confidence interval refers to the 95% confidence interval of the response curve equation.

As described above, it is possible to predict the vibration level value or the sound pressure level value for untested friction conditions using the response curve equation formed by the stick-slip measurement method according to the present disclosure.

As is apparent from the above description, in the stick-slip measurement apparatus according to the present disclosure and the stick-slip measurement method using the same, it is possible to measure noise under various conditions and environments by minimizing the number of personnel required for testing through an automated test method, to easily implement a test based on a set test plan set through the automated test method, to apply a level value based on the frequency range required by a data processing process, to identify the principle by stick-slip noise is generated by checking trends and sensitivities of each factor through a response curve equation, and to predict even parts that do not correspond to the test conditions through the response curve equation.

An additional effect of the stick-slip measurement apparatus according to the present disclosure and the stick-slip measurement method using the same is that improvement of the marketability of the parts and reduction of the design cost can be achieved through the understanding and prediction of the principle by which the stick-slip noise is generated.

Although the preferred embodiments of the present disclosure have been described above with reference to the accompanying drawings, those having ordinary skill in the art should appreciate that various modifications and alterations are possible without departing from the idea and field of the present disclosure set forth in the appended claims.

What is claimed is:

1. A stick-slip measurement apparatus comprising:
a friction test unit configured to provide at least one friction condition among a variety of friction conditions to at least two test specimens;
a measurement unit configured to acquire vibration data or sound pressure data when the at least one friction condition is applied to the at least two test specimens;
a data processing unit configured to convert the vibration data or the sound pressure data into a level value, the level value being a single feature value indicating a magnitude; and
a display unit configured to display a response curve equation graph associated with the level value.

2. The stick-slip measurement apparatus according to claim 1, wherein the friction test unit comprises:
a test jig configured to allow placement of the at least two test specimens;
a condition setting portion configured to provide friction condition information applied to the at least two test specimens;
a friction velocity variable portion configured to apply horizontal friction to the at least two test specimens based on the friction condition information; and
a vertical load variable portion configured to apply vertical load to the at least two test specimens based on the friction condition information.

3. The stick-slip measurement apparatus according to claim 1, wherein the at least two test specimens are made of a same material.

4. The stick-slip measurement apparatus according to claim 3, wherein the at least two test specimens are made of leather or Polyvinyl Chloride (PVC).

5. The stick-slip measurement apparatus according to claim 1, wherein the at least two test specimens are made of different materials.

6. The stick-slip measurement apparatus according to claim 5, wherein a first specimen of the at least two test specimens is made of polymer and a second specimen of the at least two test specimens is made of metal.

7. The stick-slip measurement apparatus according to claim 6, wherein the at least two test specimens are made of different polymer materials.

8. The stick-slip measurement apparatus according to claim 1, wherein the measurement unit comprises:
an accelerometer configured to measure a magnitude of vibration generated from the at least two test specimens.

9. The stick-slip measurement apparatus according to claim 1, wherein the measurement unit comprises:
a microphone configured to measure a magnitude of sound pressure generated from the at least two test specimens.

10. The stick-slip measurement apparatus according to claim 1, wherein the data processing unit comprises:
a data conversion portion configured to convert time domain data provided by the measurement unit into frequency domain data by a fast Fourier transform;
a band pass filter configured to extract predetermined frequency zone data from the frequency domain data; and
a level value conversion portion configured to convert the extracted data into a single decibel value.

11. The stick-slip measurement apparatus according to claim 10, wherein the data processing unit is configured to apply frequency weighting to the extracted data.

12. The stick-slip measurement apparatus according to claim 1, wherein the response curve equation graph comprises a vibration acceleration level value based on a friction velocity and a vertical load.

13. The stick-slip measurement apparatus according to claim 12, wherein the response curve equation graph comprises a predicted value for a vibration acceleration level value of an untested condition of a friction velocity and a vertical load.

14. A stick-slip measurement method comprising:
setting various test conditions for a friction velocity and a vertical load applied to at least two test specimens;
acquiring vibration data or sound pressure data generated from the at least two test specimens;
converting the vibration data or the sound pressure data into a level value, the level value being a single feature value associated with a magnitude; and
displaying a response curve equation graph associated with the level value.

15. The stick-slip measurement method according to claim 14, wherein the acquiring vibration data or sound pressure data generated from the at least two test specimens comprises:
measuring a magnitude of vibration generated from the at least two test specimens using an accelerometer; and
measuring a magnitude of sound pressure generated from the at least two test specimens using a microphone.

16. The stick-slip measurement method according to claim 14, wherein the converting the vibration data or the sound pressure data into the level value comprises:
converting time domain data measured when acquiring vibration data or sound pressure data into frequency domain data by a fast Fourier transform;
extracting predetermined frequency zone data from the frequency domain data; and
converting the extracted data into a single decibel value.

17. The stick-slip measurement method according to claim 16, wherein converting the extracted data into a single decibel value comprises applying frequency weighting to the extracted data.

18. The stick-slip measurement method according to claim 14, wherein the response curve equation graph comprises a vibration acceleration level value based on a friction velocity and a vertical load.

19. The stick-slip measurement method according to claim 18, wherein the response curve equation graph comprises a predicted value for a vibration acceleration level value of an untested condition of a friction velocity and a vertical load.

20. A method of measuring a stick-slip via a stick-slip measurement apparatus, the method comprising:
setting, via a friction test unit of the stick-slip measurement apparatus, various test conditions for a friction velocity and a vertical load applied to at least two test specimens;
acquiring, via a measurement unit of the stick-slip measurement apparatus, vibration data or sound pressure data generated from the at least two test specimens;
converting, via a data processing unit of the stick-slip measurement apparatus, the vibration data or the sound pressure data into a level value, the level value being a single feature value associated with a magnitude; and
displaying, via a display unit of the stick-slip measurement apparatus, a response curve equation graph associated with the level value.
